(19) United States
(12) Patent Application Publication
(10) Pub. No.: US 2013/0250000 A1
(43) Pub. Date: Sep. 26, 2013

(54) DROPLET EJECTION APPARATUS

(71) Applicant: FUJIFILM CORPORATION, Tokyo (JP)

(72) Inventor: Teppei YAMAMOTO, Kanagawa (JP)

(73) Assignee: FUJIFILM CORPORATION, Tokyo (JP)

(21) Appl. No.: 13/791,581

(22) Filed: Mar. 8, 2013

(30) Foreign Application Priority Data
Mar. 26, 2012 (JP) 2012-069595

(51) Int. Cl. B41J 2/165

(52) U.S. Cl. CPC B41J 2/16535
USPC 347/33

(57) ABSTRACT

A droplet ejection apparatus includes a droplet ejection head configured to eject droplets from nozzles formed in a nozzle face; and a wiping unit configured to move relative to the droplet ejection head to thereby wipe the nozzle face of the droplet ejection head with a wiping member. The wiping member includes nap-like or brush-like projections and recesses on a wiping surface, and the projections of the wiping surface enter the nozzles during wiping of the nozzle face by the wiping member.

### BACKGROUND OF THE INVENTION

1. Field of the Invention

The present invention relates to a droplet ejection apparatus, and particularly, to cleaning a nozzle face of a droplet ejection head.

2. Description of the Related Art

If droplet ejection apparatuses continue ejection of droplets, stain (mist or paper debris) adheres to a nozzle face gradually. This stain causes skewing of the ejection of the droplets. For this reason, cleaning of the nozzle face is periodically performed.

Generally, the cleaning of the nozzle face is performed by wiping the nozzle face with a blade.

On the other hand, JP2011-206975A and JP-2010-234668A suggest a method of making a traveling web to abut against the nozzle face to wipe the nozzle face.

### SUMMARY OF THE INVENTION

However, in the case of the cleaning by wiping, there was a problem that it is difficult to appropriately perform wiping. That is, there was a problem that the stain is pushed into the insides of the nozzles or the stain is left without being wiped during the wiping.

The present invention has been made in view of such a situation, and an object thereof is to provide a droplet ejection apparatus that can efficiently clean a nozzle face.

The means for solving the above problems is as follows.

According to a first aspect, there is provided a droplet ejection apparatus including a droplet ejection head configured to eject droplets from nozzles formed in a nozzle face; and a wiping unit configured to move relative to the droplet ejection head to thereby wipe the nozzle face of the droplet ejection head with a wiping member. The wiping member includes nap like or brush-like projections and recesses on a wiping surface, and the projections of the wiping surface enter the nozzles during wiping of the nozzle face by the wiping member.

According to the present aspect, nap-like or brush-like projections and recesses are formed on the wiping surface (a face that is configured to come into contact with the nozzle face) of the wiping member that wipes the nozzle face, and the projections enter the nozzles to wipe the nozzle face during wiping. This makes it possible to scrape out the stain within the nozzles with the projections and makes it possible to efficiently clean the nozzle face.

According to a second aspect, in the droplet ejection apparatus of the above first aspect, the wiping member may be constituted by a sheet having a nap on the wiping surface, and the nap may enter the nozzles during the wiping of the nozzle face by the wiping member.

According to the present aspect, the wiping member may be constituted by the sheet having a nap on the wiping surface, and the nap may enter the nozzles during wiping of the nozzle face to wipe the nozzle face.

According to a third aspect, in the droplet ejection apparatus of the above first aspect, the wiping member may be constituted by a sheet having brush bristles on the wiping surface, and the brush bristles may enter the nozzles during the wiping of the nozzle face by the wiping member.

According to the present aspect, the wiping member may be constituted by the sheet having brush bristles on the wiping surface, and the brush bristles may enter the nozzles during wiping of the nozzle face to wipe the nozzle face.

According to a fourth aspect, in the droplet ejection apparatus of the second or third aspect, a base material of the sheet may be constituted by a sheet formed through knitting or weaving using ultrafine fibers.

According to the present aspect, the base material of the sheet that constitutes the wiping member may be constituted by the sheet formed by knitting or weaving using ultrafine fibers. This makes it possible to entangle stain in the base material and makes it possible to more efficiently clean the nozzle face.

According to a fifth aspect, in the droplet ejection apparatus of any one of the second to fourth aspects, the wiping unit may further include a cleaning liquid supply unit configured to supply a cleaning liquid to the wiping member from an opposite side of the wiping surface.

According to the present aspect, the cleaning liquid may be supplied from the opposite side of the wiping surface. This makes it possible to wipe the nozzle face without the projections (naps, brush bristles, or the like) lying-down (collapsing).

According to a sixth aspect, in the droplet ejection apparatus of any one of the second to sixth aspect, the wiping member may be in a shape of a band, the wiping unit may include a wiping member drive unit configured to make the wiping member travel, and a pressing roller around which the wiping member is wound, and the wiping unit may wipe the nozzle face by making the wiping member wound around the pressing roller abut against the nozzle face.

According to the present aspect, the wiping member may be formed in a band shape (so-called web), and may be made to abut against the nozzle face while traveling. This makes it possible to always wipe the nozzle face with a clean surface.

According to a seventh aspect, in the droplet ejection apparatus of the sixth aspect, a winding angle of the wiping member to the pressing roller may be set to 180° or more.

According to the present aspect, the winding angle of the wiping member to the pressing roller may be set to 180° or more. This makes it possible to efficiently raise the projections (naps, brush bristles, or the like) and makes it possible to more efficiently clean the nozzle face.

According to an eighth aspect, in the droplet ejection apparatus of the sixth or seventh aspect, the peripheral face of the pressing roller may have a projection-recess pattern.

According to the present aspect, the projection-recess pattern may be formed on the peripheral face of the pressing roller. This makes it possible to efficiently raise the projections (naps, brush bristles, or the like) and makes it possible to more efficiently clean the nozzle face.

According to a ninth aspect, in the droplet ejection apparatus of the sixth or seventh aspect, the peripheral face of the pressing roller may have a polygonal cross-section.

According to the present aspect, the pressing roller may be formed to have polygonal cross-section. This makes it possible to efficiently raise the projections (naps, brush bristles, or the like) and makes it possible to more efficiently clean the nozzle face.

According to a tenth aspect, in the droplet ejection apparatus of any one of the sixth to ninth aspects, the wiping unit may further include a pressing force adjusting unit configured to adjust a position of the pressing roller with respect to the nozzle face to thereby adjust the pressing force of the pressing roller.

According to the present aspect, the position of the pressing roller with respect to the nozzle face may be adjusted to adjust the pressing force of the pressing roller. This makes it possible to adjust the pressing force depending on the degree of stains on the nozzle face and makes it possible to more efficiently clean the nozzle face.

According to an eleventh aspect, in the droplet ejection apparatus of any one of the second to fifth aspects, the wiping unit may wipe the nozzle face by making a pad, of which surface is covered by the wiping member, abut against the nozzle face to thereby wipe the nozzle face.

According to the present aspect, the pad, which has the wiping member covered on the surface thereof, may be made abut against the nozzle face, whereby the nozzle face is wiped.

According to a twelfth aspect, in the droplet ejection apparatus of the eleventh aspect, the wiping unit may further include a pad drive unit configured to rotate the pad.

According to the present aspect, the pad may be made to abut against the nozzle face while being rotated. This makes it possible to wipe the insides of the nozzles with the projections (naps, brush bristles, or the like) from multi-directions and makes it possible to more efficiently clean the nozzle face.

According to the above aspects, the nozzle face can be efficiently cleaned.

### BRIEF DESCRIPTION OF THE DRAWINGS

FIG. 1 is a front view showing the configuration of chief parts of one embodiment of an ink jet recording apparatus.

FIG. 2 is a plan view showing the configuration of the chief parts of one embodiment of the ink jet recording apparatus.

FIG. 3 is a side view showing the configuration of the chief parts of one embodiment of the ink jet recording apparatus.

FIG. 4 is a plan view of a nozzle face of a head.

FIG. 5 is an enlarged view showing a portion of FIG. 4 in an enlarged manner.

FIG. 6 is a side view showing the schematic configuration of a cleaning liquid imparting device.

FIG. 7 is a side view showing the schematic configuration of a wiping device.

FIG. 8 is a cross-sectional view taken along 8-8 of FIG. 7.

FIG. 9 is a side view showing the configuration of a wiping web.

FIG. 10 is a conceptual diagram of wiping by the wiping web of which the surface has been subjected to raising treatment.

FIGS. 11 A and 11B are views showing an example of the structure of the wiping web.

FIGS. 12A and 12B are views showing an example of the structure of the wiping web.

FIGS. 13A and 13B are views showing an example of the structure of the wiping web.

FIG. 14 is a view showing an example of the structure of the wiping web.

FIGS. 15A and 15B are views showing an example of the structure of the wiping web.

FIG. 16 is a view showing an example of the structure of the wiping web.

FIG. 17 is a view showing an example of the structure of the wiping web.

FIG. 18 is a side view showing another example of the wiping device.

FIG. 19 is a side view showing still another example of the wiping device.

FIG. 20 is a side view showing still further example of the wiping device.

FIG. 21 is a side view showing still further example of the wiping device.

FIG. 22 is a side view showing still further example of the wiping device.

FIG. 23 is a side view showing still further example of the wiping device.

### DESCRIPTION OF THE PREFERRED EMBODIMENTS

Hereinafter, a preferable embodiment of the invention will be described in detail according to the accompanying drawings.

In addition, in the present embodiment, a case where a droplet ejection apparatus is applied to an ink jet recording apparatus will be described as an example.

Apparatus Configuration

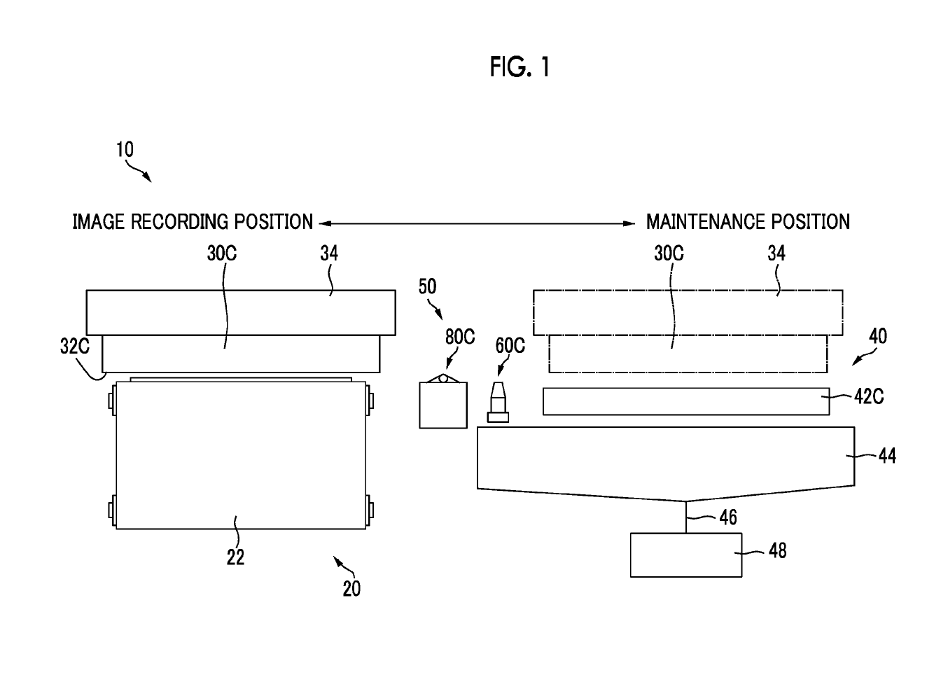

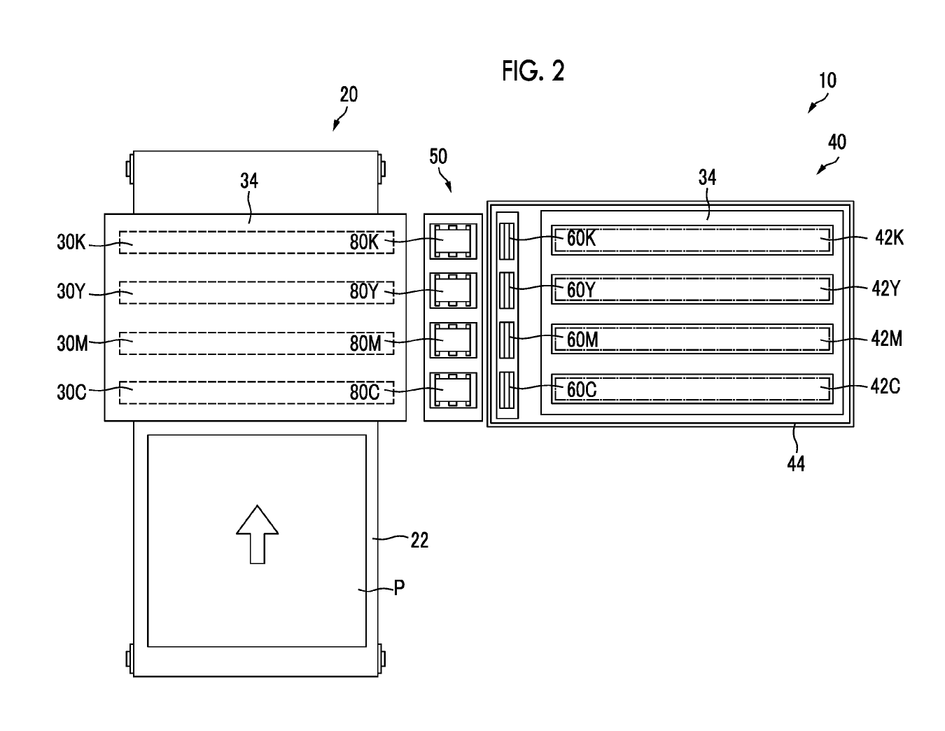

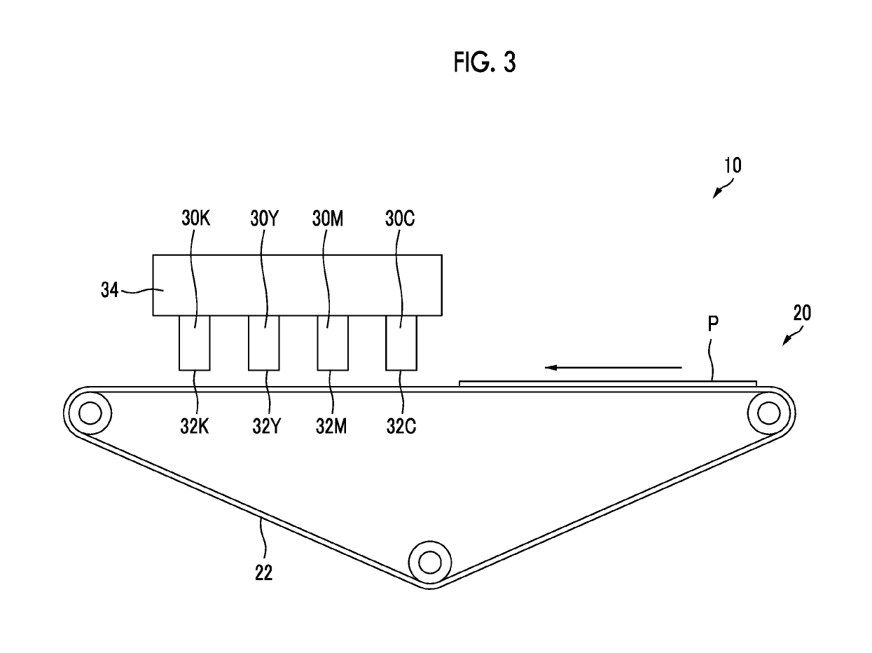

FIGS. 1 to 3 are a front view, a plan view, and a side view showing the configuration of chief parts of one embodiment of the ink jet recording apparatus, respectively.

An ink jet recording apparatus 10 shown in these drawings is a color ink jet printer that records a color image on a sheet of paper P using ink of four colors of cyan (C), magenta (M), yellow (Y), and black (K). The ink jet recording apparatus 10 includes a paper transporting device 20 that transports paper P, and ink jet heads (hereinafter referred to as “heads”) 30C, 30M, 30Y, and 30K that eject ink droplets of respective colors of C, M, Y, and K to the paper P transported by the paper transporting device 20, to record an image. The ink jet recording apparatus 10 is further equipped with a maintenance unit 40 that performs storage, maintenance, or the like of the respective heads 30C, 30M, 30Y, and 30K, and a cleaning unit 50 that cleans the nozzle faces of the respective heads 30C, 30M, 30Y, and 30K.

Paper Transporting Device

The paper transporting device 20 transports paper P with a belt. That is, the paper P is transported by suctioning and holding the paper P on the surface of an endless transporting belt 22 to travel the transporting belt 22. The travel path of the transporting belt 22 is set so that a portion of the belt becomes horizontal. The paper P is transported in a region where the transporting belt 22 travels horizontally. That is, the paper P is suctioned and held in the region where the transporting belt 22 travels horizontally, and is transported horizontally. A vacuum suction method, an electrostatic suction method, or the like can be adopted for the suction of the paper P. Since such a transporting mechanism for the paper P is a well-known technique, the description about the specific configuration thereof is omitted.

Ink Jet Head

The heads includes the head 30C that ejects ink droplets of cyan (C), the head 30M that ejects ink droplets of magenta (M), and the head 30Y that ejects ink droplets of yellow (Y), and the head 30K that ejects ink droplets of black (K). The respective heads 30C, 30M, 30Y, and 30K are constituted by line heads. In addition, since the configurations of the respective heads 30C, 30M, 30Y, and 30K are the same, each head will be described below as a head 30X (30C, 30M, 30Y, or 30K) except for a case where the heads are particularly distinguished.

A tip of the head 30X is formed with a nozzle face 32X, and the nozzle face 32X is formed with nozzles N for ejecting ink.

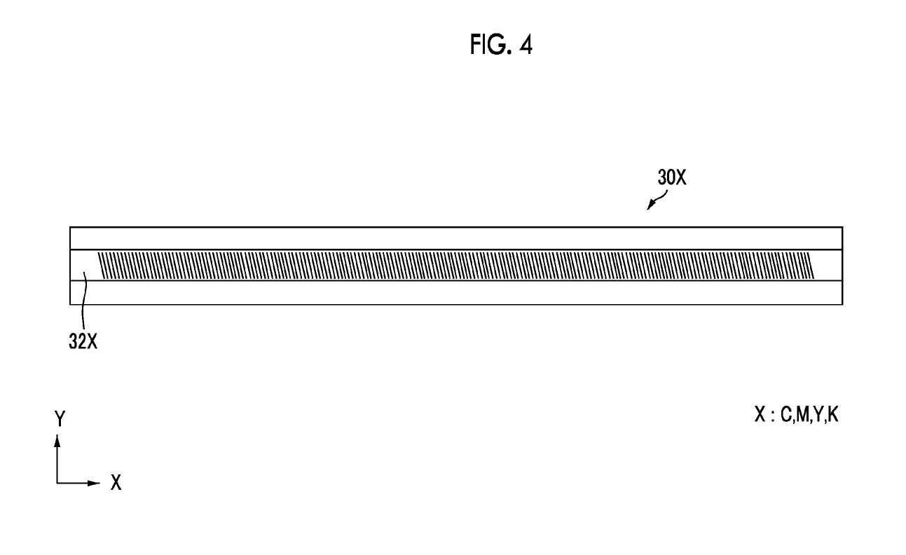

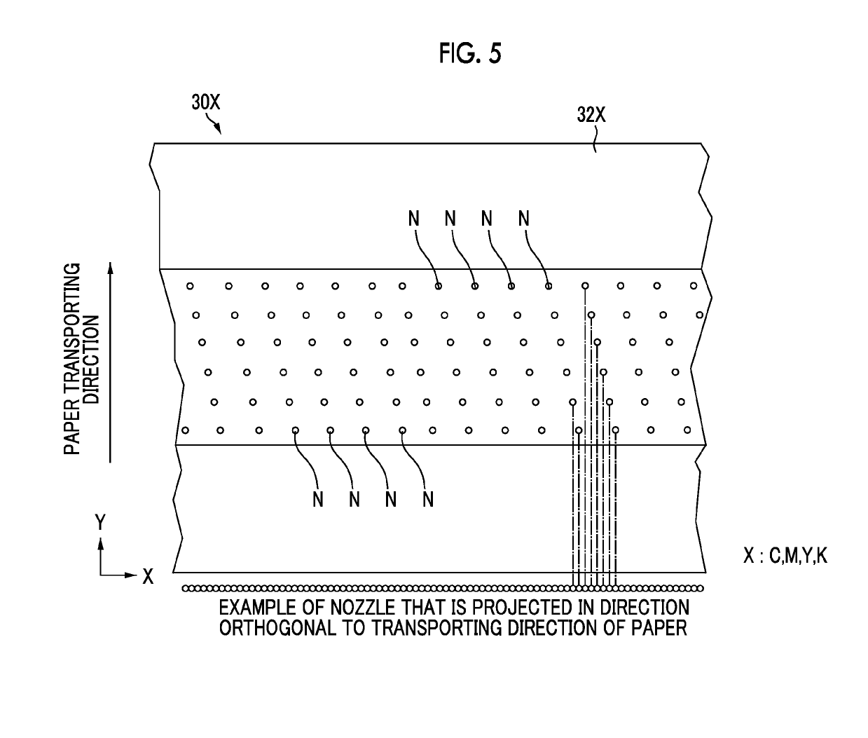

FIG. 4 is a plan view of the nozzle face of the head. Additionally, FIG. 5 is an enlarged view showing a portion of FIG. 4 in an enlarged manner.

In the head 30X of the present embodiment, the nozzle face 32X is formed in a rectangular shape. The nozzles N are formed along a longitudinal direction (a direction orthogonal to a transporting direction of the paper P: an X-axis direction in the drawing) of the nozzle face 32X. Particularly, in the head 30X of the present embodiment, a nozzle formation region is formed at the center of the nozzle face 32X in a width direction (a direction orthogonal to the longitudinal direction: a Y-axis direction in the drawing), and the nozzles N are formed in this nozzle formation region. This nozzle formation region is subjected to a liquid-repellent treatment. In addition, the liquid-repellent treatment can also be performed on the whole nozzle face 32X.

Here, in the head 30X of the present embodiment, the nozzles N are arranged in a two-dimensional matrix on the nozzle face 32X. Specifically, as shown in FIG. 4, the nozzles are arranged at constant pitches along the longitudinal direction of the nozzle face 32X, and arranged at constant pitches along a straight line that extends in a direction that inclines at a predetermined angle with respect to the longitudinal direction. By arranging the nozzles N in this way, the substantial interval of the nozzles N projected on the longitudinal direction of the head 30X can be narrowed, and high-density of the nozzles N can be achieved.

Each head 30X is attached and integrated with the head supporting frame 34. The head supporting frame 34 includes a head attachment (not shown) for attaching each head 30X, and each head 30X is detachably attached to this head attachment.

Each head 30X attached to the head supporting frame 34 is arranged so as to be orthogonal to the transporting direction of the paper P. Additionally, the respective heads are arranged at constant intervals in predetermined order (in the present example, arranged at constant intervals in order of C, M, Y, and K) along the transporting direction of the paper P.

The head attachment is liftably provided at the head supporting frame 34, and is lifted up and down by a lifting mechanism that is not shown. Each head 30X attached to the head attachment moves in an up-and-down direction (in an up-and-down direction with respect to the paper P transported by the paper transporting device 20: a Z-axis direction in the drawing) by this lifting mechanism. This makes it possible to adjust the distance (throw distance) between the nozzle face 32X and the paper P.

The head supporting frame 34 is provided so as to be horizontally movable in the direction (the X-axis direction in the drawing) orthogonal to the transporting direction (the Y-axis direction in the drawing) of the paper P by a head moving mechanism that is not shown. This head moving mechanism is constituted by, for example, a ceiling frame that is horizontally installed over the paper transporting device 20, a guide rail that is laid on the ceiling frame, a traveling body that slidingly moves on the guide rail, and driving means (for example, a feed screw mechanism or the like) that moves the traveling body along the guide rail. The head supporting frame 34 is attached to the traveling body, and moves slidingly and horizontally.

As the head supporting frame 34 moves horizontally, each head 30X attached to the head supporting frame 34 moves along the longitudinal direction (the direction orthogonal to the transporting direction of the paper P: the X-axis direction in the drawing), and moves between a predetermined “image recording position” and a “maintenance position”.

If each head 30X is located at the image recording position, each head is arranged on a transporting path of the paper P transported by the paper transporting device 20. It is thereby possible to eject ink droplets toward the paper P transported by the paper transporting device 20. That is, it is possible to record an image on the paper P.

On the other hand, if each head 30X are located at the maintenance position, each head is located at an installation position of the maintenance unit 40.

Maintenance Unit

The maintenance unit 40 includes a cap 42X (42C, 42M, 42Y, or 42K) that cover the nozzle face 32X of each head 30X. The cap 42X are provided for every head, and individually cover the nozzle face 32X of each head 30X. If each head 30X is located at the maintenance position, the head is located on the cap 42X. In a case where the operation of the apparatus stops, the nozzle face 32X of the head 30X is covered with the cap 42X. This prevents drying of ink within the nozzles.

The cap 42X includes a pressuring/suctioning mechanism (not shown) for pressurizing and suctioning the insides of the nozzles. In a case where non-ejection or the like has occurred, recovery treatment is appropriately performed by using the pressuring/suctioning mechanism of the cap 42X.

A waste liquid tray 44 is arranged below the cap 42X. The ink suctioned by the cap 42X is discarded to the waste liquid tray 44, and is recovered in a waste liquid tank 48 via waste liquid recovery piping 46.

Cleaning Unit

The cleaning unit 50 is arranged between the paper transporting device 20 and the maintenance unit 40. The cleaning unit 50 cleans the nozzle face 32X of each head 30X, while the head 30X moves from the maintenance position to the image recording position.

The cleaning unit 50 includes a cleaning liquid imparting device 60X (60C, 60M, 60Y, or 60K) that imparts a cleaning liquid to the nozzle face 32X of the head 30X, and a wiping device 80X (80C, 80M, 80Y, or 80K) that wipes the nozzle face 32X to which the cleaning liquid is imparted with a web. The wiping device 80X is equivalent to a wiping unit. The cleaning liquid imparting device 60X and the wiping device 80X are provided for every head. That is, the cleaning liquid is individually imparted to the nozzle face 32X (32C, 32M, 32Y, or 32K) of each head 30X (30X, 30M, 30Y, or 30K) by the cleaning liquid imparting device 60X (60C, 60M, 60Y, or 60K) provided for every head. Additionally, the nozzle face 32X (32C, 32M, 32Y, or 32K) of each head 30X (30X, 30M, 30Y, or 30K) is individually wiped by the wiping device 80X (80C, 80M, 80Y, or 80K) provided for every head.

Cleaning Liquid Imparting Device

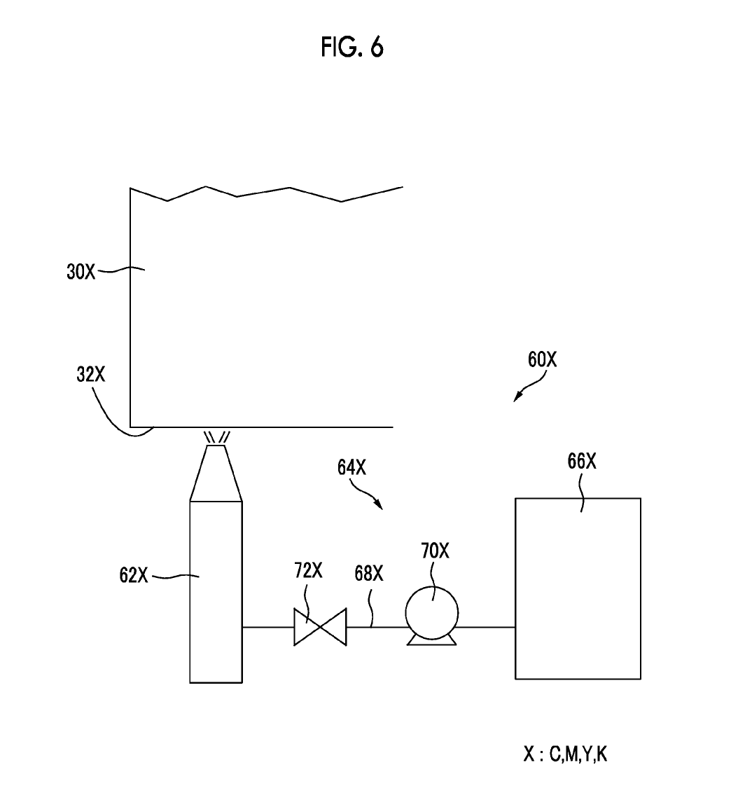

FIG. 6 is a side view showing the schematic configuration of the cleaning liquid imparting device.

As described above, the cleaning liquid imparting device 60X imparts a cleaning liquid to the nozzle face 32X (32C, 32M, 32Y, or 32K) of each head 30X (30X, 30M, 30Y, or 30K). In addition, the configurations of the respective cleaning liquid imparting devices 60X are the same.

As shown in FIG. 6, the cleaning liquid imparting device 60X includes a cleaning liquid nozzle 62X that imparts a cleaning liquid to the nozzle face 32X of the head 30X, and a cleaning liquid supply device 64X that supplies a cleaning liquid to the cleaning liquid nozzle 62X.

The cleaning liquid nozzle 62X is installed on a movement path of the head 30X. The head 30X passes above the cleaning liquid nozzle 62X.

The cleaning liquid nozzle 62X is installed so that the jetting port thereof is directed upward. When the head 30X passes above the cleaning liquid nozzle 62X, a cleaning liquid is imparted to the head 30X by jetting the cleaning liquid from the jetting port.

The cleaning liquid supply device 64X includes a cleaning liquid tank 66X, cleaning liquid piping 68X, a cleaning liquid pump 70X, and a cleaning liquid valve 72X. The cleaning liquid tank 66X stores a cleaning liquid. The cleaning liquid piping 68X connects the cleaning liquid tank 66X and the cleaning liquid nozzle 62X. The cleaning liquid pump 70X is installed in the middle of the cleaning liquid piping 68X, and the cleaning liquid stored in the cleaning liquid tank 66X is fed to the cleaning liquid nozzle 62X via the cleaning liquid piping 68X. The cleaning liquid valve 72X is installed in the middle of the cleaning liquid piping 68X, and opens and closes a conduit of the cleaning liquid piping 68X. By opening the cleaning liquid valve 72X and driving the cleaning liquid pump 70X, the cleaning liquid stored in the cleaning liquid tank 66X is supplied to the cleaning liquid nozzle 62X via the cleaning liquid piping 68X, and is jetted from the jetting port of the cleaning liquid nozzle 62X.

Wiping Device

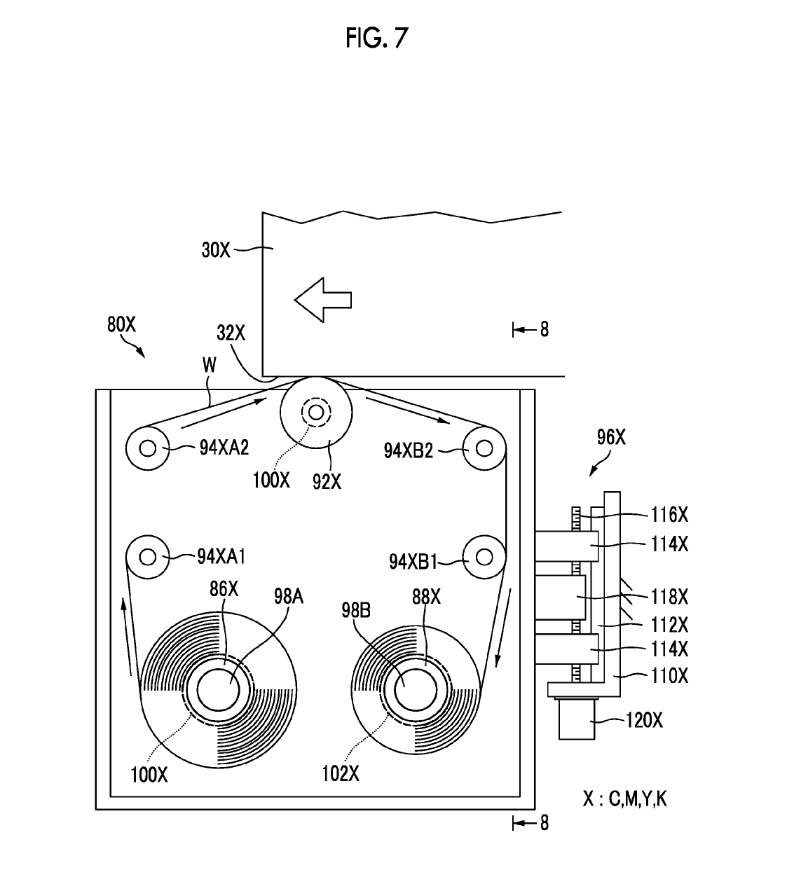

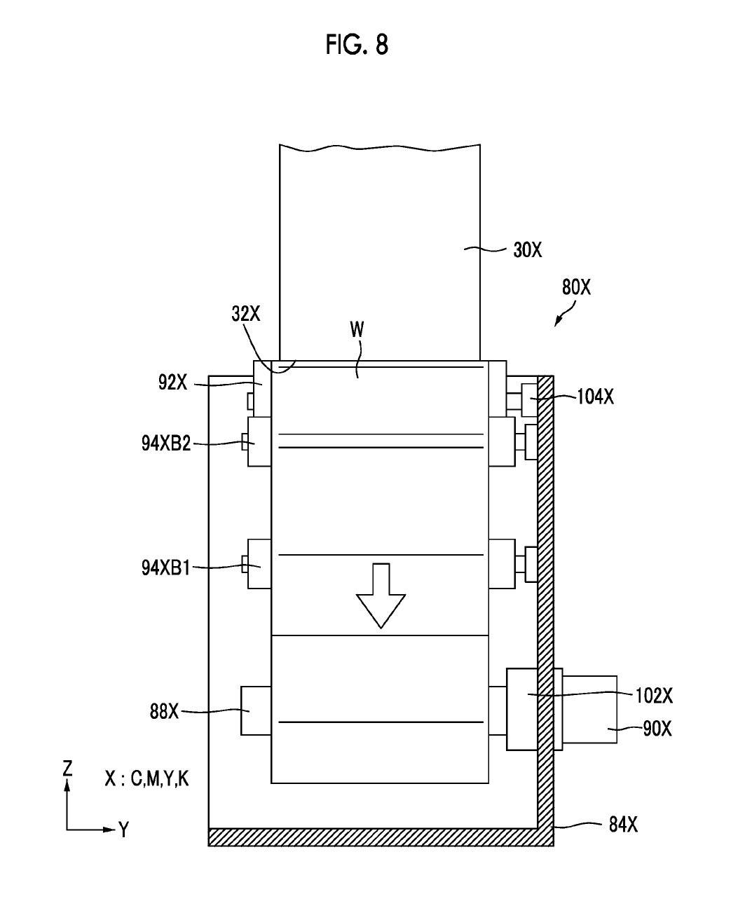

FIG. 7 is a side view showing the schematic configuration of the wiping device. FIG. 8 is a cross-sectional view taken along 8-8 of FIG. 7.

As described above, the wiping device 80X wipes the nozzle face 32X (32C, 32M, 32Y, or 32K) of each head 30X (30X, 30M, 30Y or 30K). That is, the wiping device 80X makes a wiping web W abut against the nozzle face 32X of the moving head 30X, thereby wiping the nozzle face 32X. In addition, the configurations of the respective wiping devices 80X are the same.

As shown in FIGS. 7 and 8, the wiping device 80X includes a wiping device body frame 84X, a feeding-out shaft 86X that feeds out the wiping web W, a winding-up shaft 88X that winds up the wiping web W (wiping member), a winding-up motor 90X that winds up the wiping web W, a pressing roller 92X that brings the wiping web W into press contact with the nozzle face 32X, a guide roller 94XA1, 94XA2, 94XB1, and 94XB2 that guides traveling of the wiping web W, and a lifting device 96X that lifts and lowers the wiping device body frame 84X.

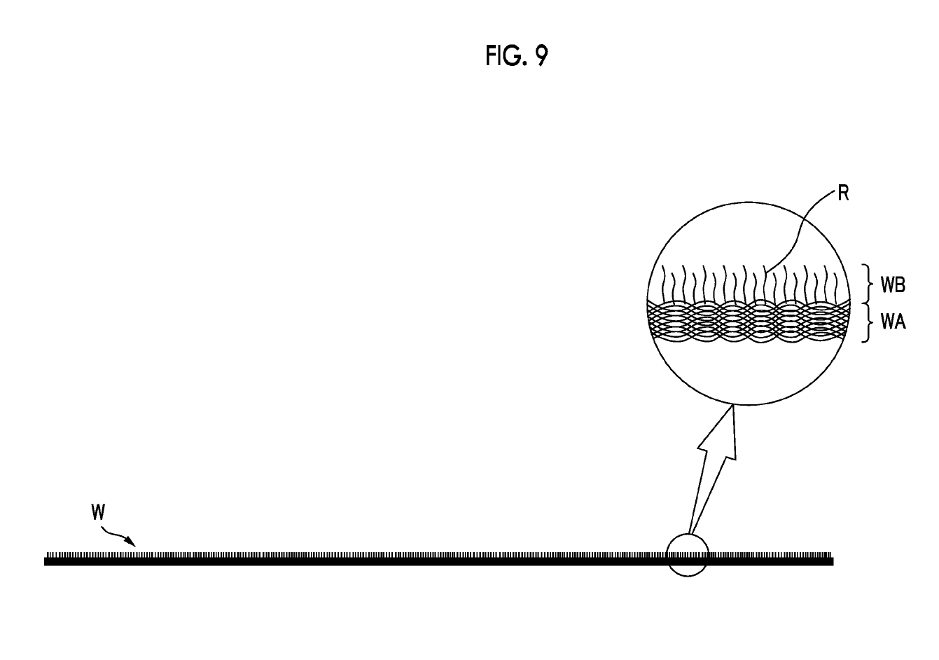

The wiping web W is made of a band-shaped sheet of which the surface (a surface that wipes the nozzle face: wiping surface) is subjected to raising treatment (i.e., a band-shaped sheet that has a napped surface by virtue of fibers). Specifically, as shown in FIG. 9, for example, the wiping web is constituted by a base texture portion (base material) WA formed through knitting or weaving using ultrafine fibers, such as polyethylene terephthalate (PET), polyethylene (PE), and nylon (NY) (registered trademark), and a raised portion WB including ultrafine raised yarns R (for example, ultrafine fibers, such as PET, PE, and NY) that are woven or knitted into the base texture portion WA. That is, in the present embodiment, the wiping web W may be constituted by, for example, fabric with a napped surface (so-called raised fabric).

The wiping web W is formed with almost the same width as the width (width in the direction orthogonal to the longitudinal direction) of the nozzle face 32X so that the whole region of the nozzle face 32X can be wiped by one wiping. Additionally, the wiping web W is wound around a core 98A for feeding-out, is provided in the shape of a roll, and has a core 98B for winding-up attached to the tip thereof.

The feeding-out shaft 86X and the winding-up shaft 88X are arranged parallel to each other, and are arranged so as to be orthogonal to a movement direction (in the present embodiment, the longitudinal direction (the X-axis direction in FIGS. 4 and 5) of the head 30X) of the head 30X, respectively. Additionally, the feeding-out shaft and the winding-up shaft are arranged parallel to the nozzle face 32X of the head 30X, respectively.

The wiping device body frame 84X is provided with a feeding-out shaft supporting portion 100X that supports the feeding-out shaft 86X, and a winding-up shaft supporting portion 102X that supports the winding-up shaft 88X. The feeding-out shaft 86X is supported by the feeding-out shaft supporting portion 100X, and is attached to the wiping device body frame 84X. Additionally, the winding-up shaft 88X is supported by the winding-up shaft supporting portion 102X, and is attached to the wiping device body frame 84X. In the present embodiment, the feeding-out shaft 86X and the winding-up shaft 88X are attached so as to be arranged in parallel at a constant interval in a lateral direction (the X-axis direction).

The core 98A for feeding-out is mounted on the feeding-out shaft 86X, and the core 98B for winding-up is mounted on the winding-up shaft 88X. Thereby, the wiping web W is mounted on the wiping device 80X.

In addition, the feeding-out shaft 86X includes a friction mechanism and a reverse rotation preventing mechanism that are not shown, and is configured so as to rotate only in one direction (a feeding-out direction of the wiping web W) with constant resistance. This makes it possible to impart a constant load when the wiping web W is fed out.

Additionally, the winding-up shaft 88X includes a torque limiter that is not shown, and is configured so as to slide if a fixed load (torque) or more is applied in a rotational direction. This makes it possible to prevent a tension more than necessary from being applied to the wiping web W and to always maintain a fixed tension to cause the wiping web W to travel.

The winding-up motor 90X is provided at the wiping device body frame 84X. The winding-up motor 90X is coupled to the winding-up shaft 88X and rotationally drives the winding-up shaft 88X. Accordingly, the wiping web W can be wound up around the core 98B for winding-up mounted on the winding-up shaft 88X by driving the winding-up motor 90X. In the present configuration, the winding-up shaft 88X and the winding-up motor 90X are equivalent to a wiping member drive unit.

The pressing roller 92X is arranged between the feeding-out shaft 86X and the winding-up shaft 88X, and is arranged parallel to the feeding-out shaft 86X and the winding-up shaft 88X.

The wiping device body frame 84X is provided with a pressing roller supporting portion 104X that supports the pressing roller 92X. The pressing roller 92X is rotatably supported by the pressing roller supporting portion 104X. The pressing roller 92X is constituted by a rubber roller (a roller of which at least the outer peripheral portion is formed from rubber), and has a length corresponding to the width of the wiping web W.

The plurality of guide roller 94XA1, 94XA2, 94XB1, and 94XB2 guide traveling of the wiping web W so that the wiping web W fed out from the feeding-out shaft 86X travels along a predetermined travel path and is wound up around the winding-up shaft 88X. The plurality of guide idlers includes a first feeding-out-side guide roller 94XA1 and a second feeding-out-side guide roller 94XA2 on the feeding-out side, and a first winding-up-side guide roller 94XB1 and a second winding-up-side guide roller 94XB2 on the winding-up side. The guide rollers 94XA1 and 94XA2 on the feeding-out side guide the wiping web W so that the wiping web W fed out from the feeding-out shaft 86X travels along a predetermined travel path and is wound around the pressing roller 92X. The guide roller 94XB1 and 94XB2 on the winding-up-side guide the wiping web W so that the wiping web W wound around the pressing roller 92X travels along a predetermined travel path and is wound up around the winding-up shaft 88X.

The guide idlers on the feeding-out side include the first feeding-out-side guide roller 94XA1 and the second feeding-out-side guide roller 94XA2. The wiping web W fed out from the feeding-out shaft 86X is wound around the first feeding-out-side guide roller 94XA1 and the second feeding-out-side guide roller 94XA2, and are wound around the pressing roller 92X.

The guide idlers on the winding-up side include the first winding-up-side guide roller 94XB1 and the second winding-up-side guide roller 94XB2. The wiping web W wound around the pressing roller 92X is wound around the second winding-up-side guide roller 94XB2 and the first winding-up-side guide roller 94XB1, and is wound up around the winding-up shaft 88X.

Here, the second feeding-out-side guide roller 94XA2 and second winding-up-side guide roller 94XB2 arranged immediately before and immediately after the pressing roller 92X are arranged bilaterally symmetrically with respect to the pressing roller 92X, and are arranged so that the wiping web W is wound around the upper peripheral face of the pressing roller 92X. That is, the second feeding-out-side guide roller 94XA2 and the second winding-up-side guide roller 94XB2 are arranged at positions lower than the pressing roller 92X, and are arranged so that the wiping web W is wound around the pressing roller 92X in the shape of a mountain.

The lifting device 96X is attached to a body frame of the ink jet recording apparatus 10, and moves the wiping device body frame 84X in the up-and-down direction (the Z-axis direction in the drawing). The lifting device 96X is constituted by a so-called feeding-out screw mechanism, and includes a lifting device base frame 110X, a guide rail 112X, sliders 114X, a threaded rod 116X, a nut member 118X, and a motor 120X for lifting.

The lifting device base frame 110X is attached to the body frame (not shown) of the ink jet recording apparatus 10.

The guide rail 112X is laid on the lifting device base frame 110X. The guide rail 112X is laid along the up-and-down direction (the Z-axis direction in the drawing).

The sliders 114X are provided so as to be slidable along the guide rail 112X. The wiping device body frame 84X is attached to the sliders 114X, and is provided so as to be slidable in the up-and-down direction.

The threaded rod 116X is rotatably supported by the lifting device base frame 110X via a bearing (not shown). The threaded rod 116X is disposed parallel to the guide rail 112X.

The nut member 118X is attached to the threaded rod 116X. The wiping device body frame 84X is coupled to the nut member 118X. Thereby, if the threaded rod 116X is rotated, the wiping device body frame 84X moves up and down according to the rotational direction and rotational amount of the threaded rod.

The motor 120X for lifting is provided at the lifting device base frame 110X to rotationally drive the threaded rod 116X.

The lifting device 96X is configured as described above. If the motor 120X for lifting is driven and the threaded rod 116X is rotated, the wiping device body frame 84X moves up and down according to the rotational direction and rotational direction of the motor. The wiping device 80X moves between a predetermined “wiping position” and a “standby position” in the up-and-down direction (the Z-axis direction in the drawing) as the lifting device 96X is driven.

The wiping position is set at a position where the pressing roller 92X is brought into press contact with the nozzle face 32X of the head 30X that passes above the wiping device 80X. Additionally, the standby position is set at a position where the pressing roller 92X is spaced apart with a predetermined interval from the nozzle face 32X of the head 30X that passes above the wiping device 80X. Accordingly, if the wiping device 80X is moved to the wiping position, the nozzle face 32X of the head 30X can be made to abut against the wiping web W wound around the pressing roller 92X. Additionally, if the wiping device 80X is moved to the standby position, the head 30X can be passed without making the wiping web W abut against the nozzle face 32X of the head 30X.

The wiping device 80X is configured as described above. In the wiping device 80X, the wiping web W travels while being wound up around the winding-up shaft 88X by driving the winding-up motor 90X. Then, by moving the wiping device 80X to the wiping position in a state where the wiping web W is made to travel, the traveling wiping web W can be made to abut against the nozzle face 32X of the head 30X that travels between the image recording position and the maintenance position, and the nozzle face 32X of the head 30X can be wiped by the traveling wiping web W.

The ink jet recording apparatus 10 of the present embodiment is configured as described above. In addition, the operation of the overall apparatus is controlled by a control device that is not shown. The control device controls respective units of the ink jet recording apparatus 10 according to a predetermined control program.

Operation

Next, the operation of the ink jet recording apparatus 10 of the present embodiment configured as described above will be will be described.

Image Recording Method

First, an image recording method using the ink jet recording apparatus 10 of the present embodiment will be outlined.

As described above, recording of an image is performed in a state where the head 30X is moved to the image recording position. Accordingly, in a case where the head 30X is located at the maintenance position, the head 30X is moved to the image recording position. As the head 30X moves to the image recording position, each head 30X is set above the paper transporting device 20, and recording of an image becomes possible.

Paper P is fed to the paper transporting device 20 by a paper feed mechanism that is not shown. In addition, a predetermined pretreatment (for example, application of a treatment liquid having the function of agglomerating a color material) is performed if necessary. The paper transporting device 20 receives the paper P fed by the paper feed mechanism, and transports the paper horizontally.

Each head 30X ejects ink droplets toward the paper P transported by the r transporting device 20, and records an image on the surface of the paper P.

The paper P on which the image has been recorded is recovered from the paper transporting device 20 by a recovery mechanism that is not shown. In addition, treatment, such as drying or fixing, is performed if necessary.

By feeding the paper P continuously, recording processing of an image is continuously performed.

Cleaning Method of Nozzle Face

Next, a cleaning method of the nozzle face will be described.

In the ink jet recording apparatus, skewing of ejection of ink droplets is caused if stain (mist or paper debris) adheres to the nozzle face 32X. For this reason, cleaning of the nozzle face 32X is periodically performed. Additionally, water droplets may adhere to the nozzle face 32X if the nozzle face is covered with the cap 42X. Even in such a case, cleaning (wiping) of the nozzle face 32X is performed.

As described above, the cleaning of the nozzle face 32X is performed in the process in which the head 30X is moved from the maintenance position to the image recording position. Accordingly, in a case where the head 30X is located at the image recording position, the head 30X is moved to the maintenance position.

If a cleaning command is input to the control device (not shown) of the ink jet recording apparatus 10, the control device move the wiping device 80X to the wiping position. It is thereby possible to make the wiping web W abut against the nozzle face 32X of the head 30X that passes above the wiping device 80X.

If the wiping device 80X moves to the wiping position, the control device drives the head moving mechanism (not shown) to move the head 30X at a constant speed toward the image recording position from the maintenance position.

If the head 30X moves toward the image recording position, the tip (here, an end portion on the side of the image recording position) of the head 30X in the movement direction reaches an installation position of the cleaning liquid imparting device 60X. The control device drives the cleaning liquid supply device 64X in accordance with the timing at which the tip of the head 30X in the movement direction reaches the installation position of the cleaning liquid imparting device 60X, and supplies a cleaning liquid to the cleaning liquid nozzle 62X. Thereby, the cleaning liquid is jetted from the cleaning liquid nozzle 62X.

As described above, the cleaning liquid nozzle 62X is installed so that the jetting port thereof is directed upward. Accordingly, if the head 30X passes above the cleaning liquid nozzle 62X, the cleaning liquid jetted from the jetting port is imparted to the nozzle face 32X of the head 30X. This makes the nozzle face 32X of the head 30X wet.

If the head 30X moves further, the tip of the head 30X in the movement direction reaches an installation position of the wiping device 80X. The control device drives the winding-up motor 90X in accordance with the timing at which the tip of the head 30X reaches the installation position of the wiping device 80X, and makes the wiping web W travel.

As described above, if the wiping device 80X is located at the wiping position, it is possible to make the wiping web W be wound around the pressing roller 92X abut against the nozzle face 32X of the head 30X. As the head 30X passes above the wiping device 80X, the traveling wiping web W abuts against the nozzle face 32X, and the nozzle face 32X is wiped by the wiping web W.

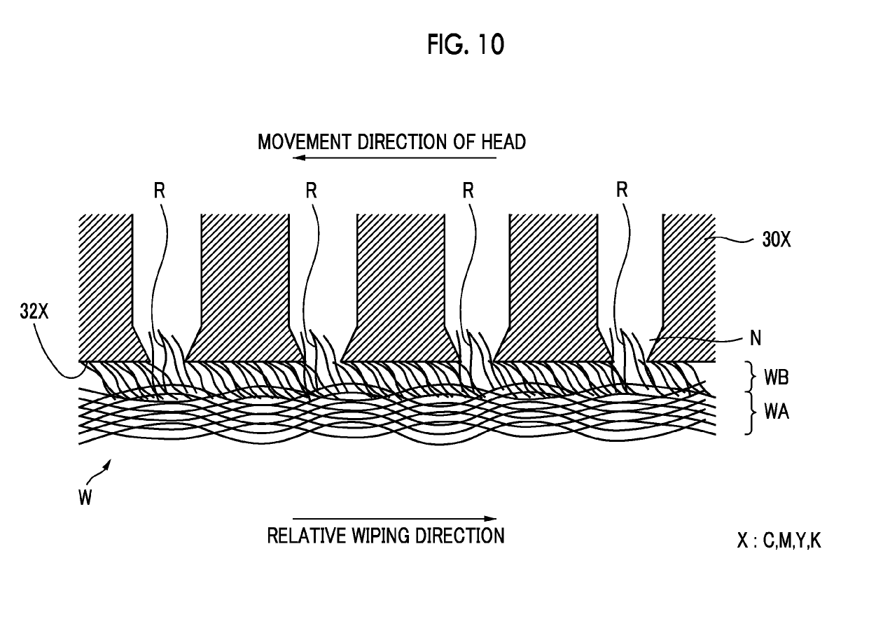

Here, as described above, the surface of the wiping web W of the present embodiment is subjected to raising treatment. For this reason, as shown in FIG. 10, the raised yarns R raised from the base texture portion WA wipes the nozzle face 32X while entering individual nozzles formed in the nozzle face 32X. This makes it possible to scrape off stain within the nozzles and also makes it possible to scrape off the stain with the raised yarns R. Since the stain scraped off the insides of the nozzles or the stain present on the nozzle face 32X can be entangled in the base texture portion WA, the stain can be wiped without being left on the nozzle face 32X. In this case, the stain present on the nozzle face 32X can also be efficiently scraped off by the action of the raised yarns R.

In this way, in the ink jet recording apparatus 10 of the present embodiment, the nozzle face 32X is made wet by imparting a cleaning liquid to the nozzle face 32X. Thereafter, in the ink jet recording apparatus, the traveling wiping web W is pressed against the nozzle face 32X to thereby wipe the nozzle face 32X and clean the nozzle face 32X.

If the head 30X moves and a rear end (here, an end portion on the side of the maintenance position) of the head 30X in the movement direction reaches the installation position of the cleaning liquid imparting device 60X, the control device stops the driving of the cleaning liquid supply device 64X. This stops the jetting of the cleaning liquid from the cleaning liquid nozzle 62X.

If the head moves further and the rear end of the head 30X in the movement direction reaches the installation position of the wiping device 80X, the control device drives the lifting device 96X to move the wiping device 80X to the standby position. Thereafter, the control device stops the driving of the winding-up motor 90X, and stops the traveling of the wiping web W.

The cleaning of the nozzle face 32X of the head 30X is ended through a series of the above steps.

As described above, in the ink jet recording apparatus 10 of the present embodiment, the nozzle face 32X is wiped with the wiping web W of which the surface has been subjected to raising treatment, when the nozzle face 32X is wiped. This makes it possible to perform even cleaning of the insides of the nozzles that cannot be performed in the wiping web of the related art and makes it possible to efficiently wipe the nozzle face 32X. Additionally, the stain present on the nozzle face 32X can also be removed by the action of the raised portion WB. Additionally this makes it possible to always obtain an excellent cleaning result without being influenced by the abutment pressure of the wiping web W.

Wiping Web

In the ink jet recording apparatus of the present embodiment, one of the purposes of using the wiping web W of which the surface has been subjected to raising treatment is to scrape off stain within nozzles with portions of the raised yarns R. Accordingly, a wiping web having surface texture such that the portions of the raised yarns R can enter the nozzles during wiping is used as the wiping web W. Accordingly, the wiping web W to be used is appropriately selected according to the size, shape, or the like of nozzles formed in a nozzle face to be wiped. That is, a wiping web W is used having raised yarns R of thickness and length capable of entering the nozzles formed in the nozzle face to be wiped.

Additionally, since the raised yarns R are likely to enter the nozzles during wiping, it is preferable to have moderate elasticity (so-called stiffness). Accordingly, if the length of the raised yarns R is excessively large, elasticity become weaker and the raised yarns do not easily enter the nozzles. Thus, it is preferable to adjust the length of the raised yarns to a suitable length.

For example, in a case where a nozzle face formed with nozzles with a taper in which the diameter of an opening portion is φ16 μm and the length of a tapered portion is 50 μm is wiped, it is preferable to set the thickness of the raised yarns R, which constitute the raised portion WB of the wiping web W, to φ5 μm or less. Additionally, it is preferable to set the length to 10 μm or more and 50 μm or less. That is, it is preferable to set the thickness of the raised yarns R to be equal to or less than half of the diameter of the opening portions of the nozzles. This makes it possible for the raised yarns R to enter the nozzles during wiping. Additionally, in a case where the nozzle face 32X formed with the nozzles with a taper is wiped, it is preferable that the length of the raised yams R correspond to the length of the tapered portion. This makes it possible to for the raised yarns R to enter even the insides of the nozzles and makes it possible to sufficiently scrape off the stain inside the nozzles.

In addition, since the raised yarns R become new foreign matter if left behind within the nozzles, it is preferable that the raised yarns be firmly anchored to the base texture portion WA.

Additionally, it is preferable that the raised yarns R be densely disposed so that the raised portion WB can efficiently trap stain between the raised yarns R.

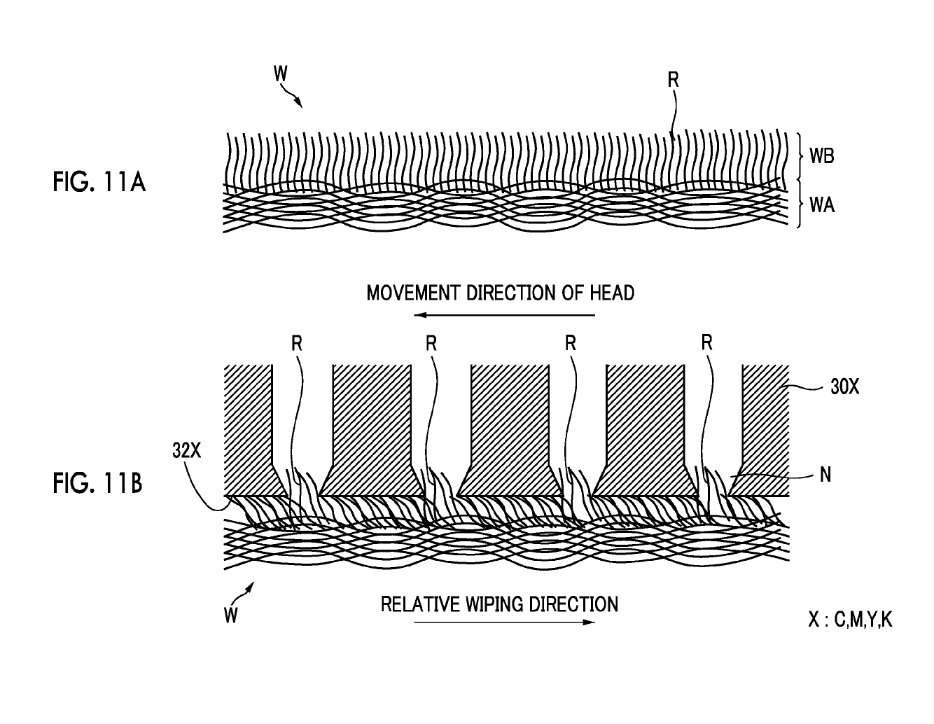

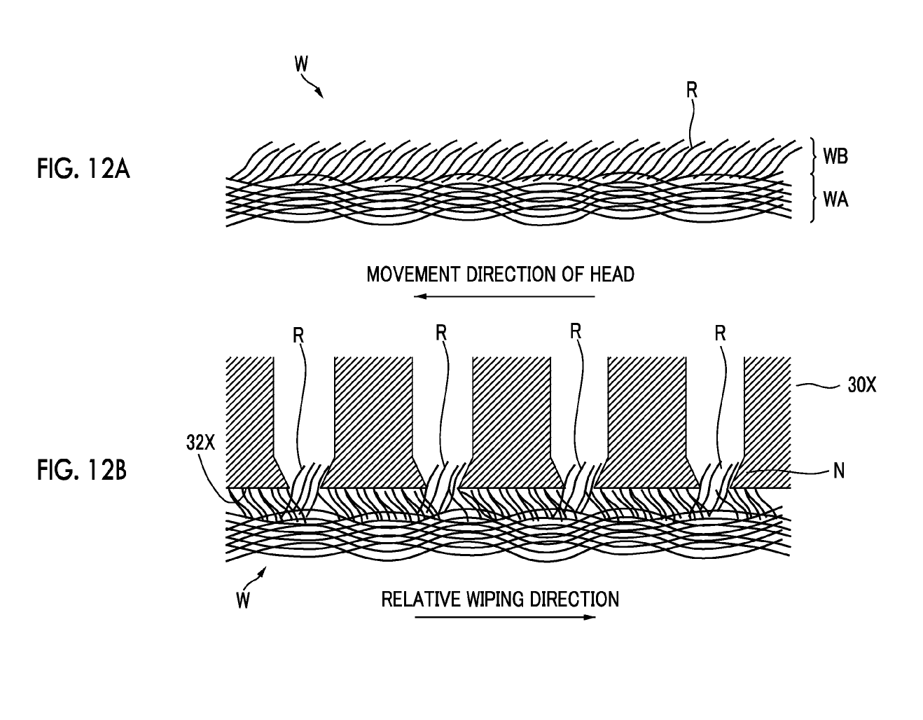

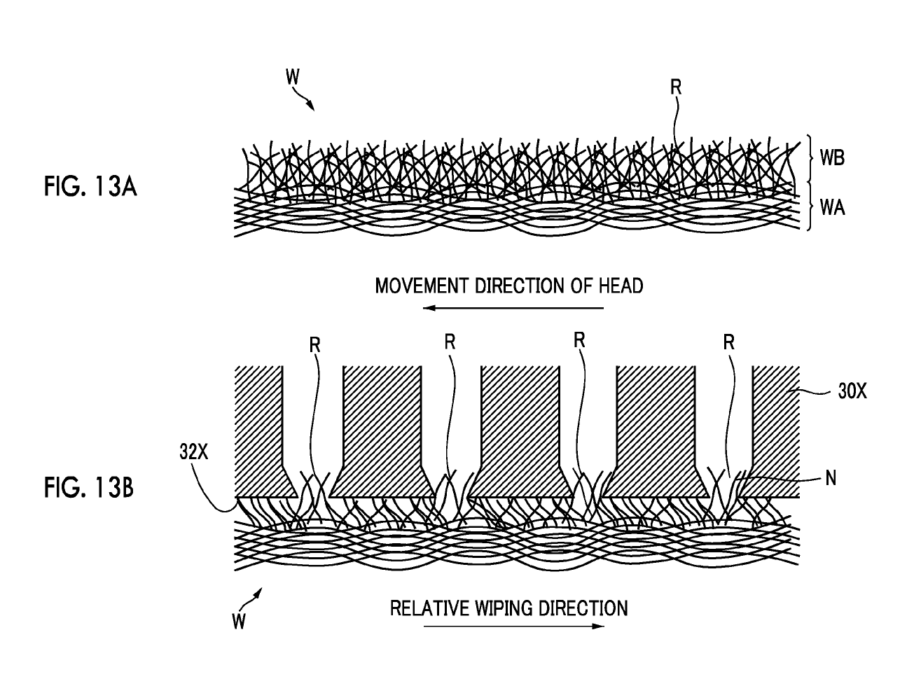

Additionally, the raised yarns R, as shown in FIGS. 11A and 11B, may be arranged so as to be raised substantially perpendicularly to the base texture portion WA. Additionally, as shown in FIGS. 12A and 12B, the raised yarns may be arranged so as to lie down in a direction against in the wiping direction (a direction in which the raised yarns moves relative to the nozzle face). That is, a peculiarity may be given to the raised yams so that the raised yarns R lie down in the direction against the wiping direction. Additionally, as shown in FIGS. 13A and 13B, the raised yarns R may be arranged in a state where the raised yarns R are randomly directed to various directions.

By laying down the raised yarns R in the direction against the wiping direction as shown in FIGS. 12A and 12B, the raised yarns R easily enter the nozzles, and the insides of the nozzles can be more effectively cleaned during wiping.

Similarly, by randomly directing the raised yarns R to various directions as shown in FIGS. 13A and 13B, the raised yarns R easily enter the nozzles, and the insides of the nozzles can be more effectively cleaned during wiping. Additionally, the stain that has adhered to the nozzle face 32X can also be more efficiently scraped off

Stain can be efficiently entangled by constituting the base texture portion (base) WA of the wiping web W with a sheet formed through knitting or weaving using ultrafine fibers. This makes it possible to prevent stain from being pushed into the nozzles.

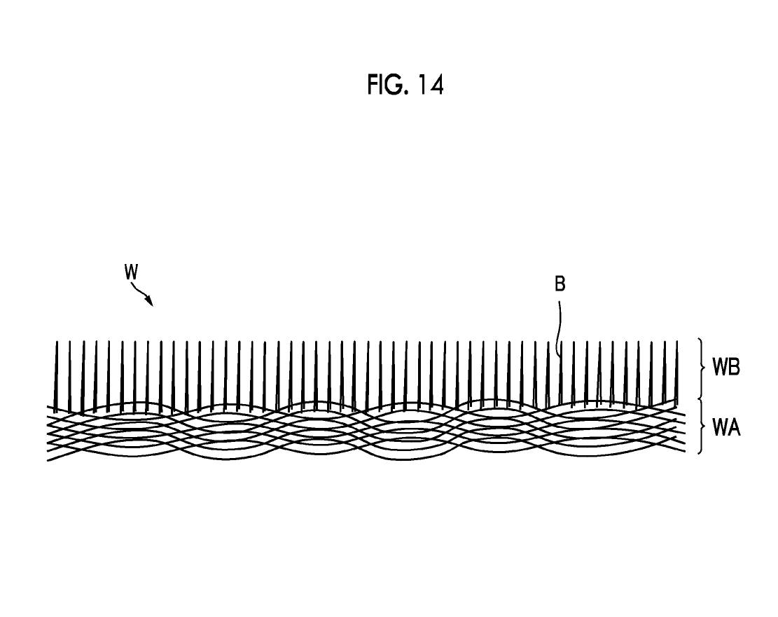

In addition, as described above, one of the purposes of using the wiping web W of which the surface has been subjected to raising treatment is to scrape off the stain within the nozzles with portions of the raised yarns R. Accordingly, a variety of sheets may be used as the wiping web W, which has irregularities (projections and recesses) like such naps formed on the surface thereof. Accordingly, for example, as shown in FIG. 14, a sheet in the form in which brush bristles B are planted on the surface of the base texture portion WA can also be similarly used as the wiping web W.

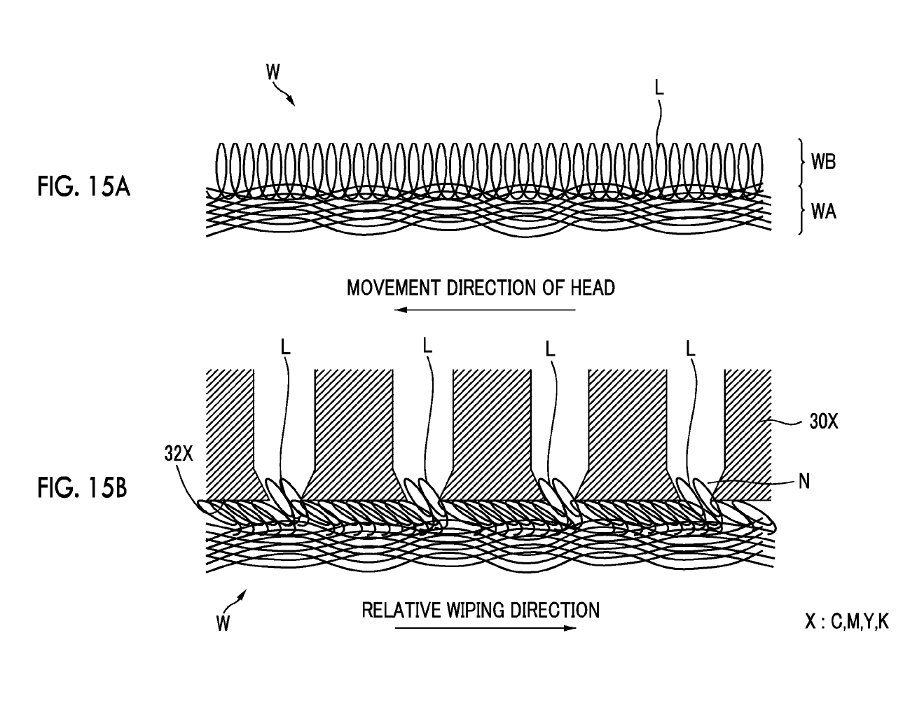

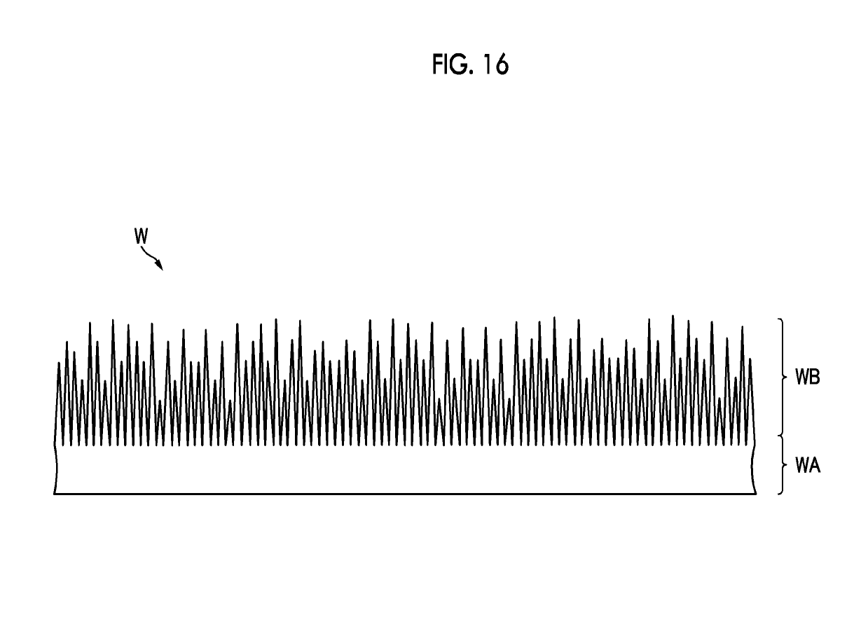

Additionally, the shape of the raised portion (projection) of the wiping web W may be a variety of shapes as long as the raised portion can enter the nozzles. Accordingly, as shown in FIGS. 11A and 11B, not only the wiping web W (a so-called velvet-like wiping web W) with a napped surface but also, for example, a wiping web W (a so-called pile-woven wiping web) in which raised yarns L are raised in the shape of a loop (in the shape of a ring) as shown in FIGS. 15A and 15B can be used. Additionally, the same effects can be obtained even if a wiping web W with a large surface roughness is used as shown in FIG. 16. In this case, the surface roughness of a wiping web to be used is appropriately selected according to the size, shape, or the like of nozzles formed in a nozzle face to be wiped. For example, in a case where the above nozzle face formed with nozzles with a taper in which the diameter of an opening portion is φ16 μm and the length of a tapered portion is 50 μm is wiped, a wiping web W of which the centerline surface roughness of the surface (wiping surface) is about 10 μmRa.

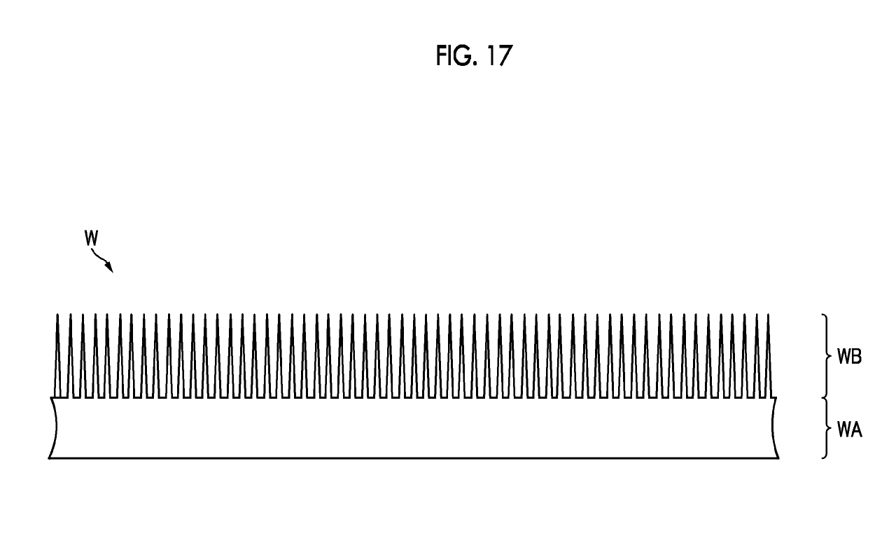

Additionally, the base texture portion WA is not necessarily knitted fabric or woven fabric, and can also be constituted with a sheet made of rubber. That is, as shown in FIG. 17, one obtained by integrally forming irregularities (projections and recesses) like a nap or like a brush on the surface of the sheet made of rubber can also be used as the wiping web W. In this case, although stain cannot be absorbed in the base texture portion WA, the insides of the nozzles can be effectively cleaned. Accordingly, in a case where the wiping web W is constituted with the sheet made of rubber in this way, the nozzle face may be configured so as to be separately wiped with a sheet having water absorptivity. Otherwise, the wiping web made of rubber having irregularities (projections and recesses), and the wiping web (fabric with a smooth surface) having usual water absorptivity may be configured to be replaceable with each other, and may be appropriately selected.

Modification

Modification 1

As described above, the nozzle face 32X can be efficiently cleaned by wiping the nozzle face 32X with the wiping web W of which the surface has been subjected to raising treatment (including the wiping web that has irregularities like a nap or like a brush on the surface thereof). This is because the insides of the nozzles can also be simultaneously cleaned when the portions of the raised yarns R enter the nozzles.

Accordingly, in order to more efficiently clean the insides of the nozzles, it is preferable to perform wiping in a state where the raised portions are raised.

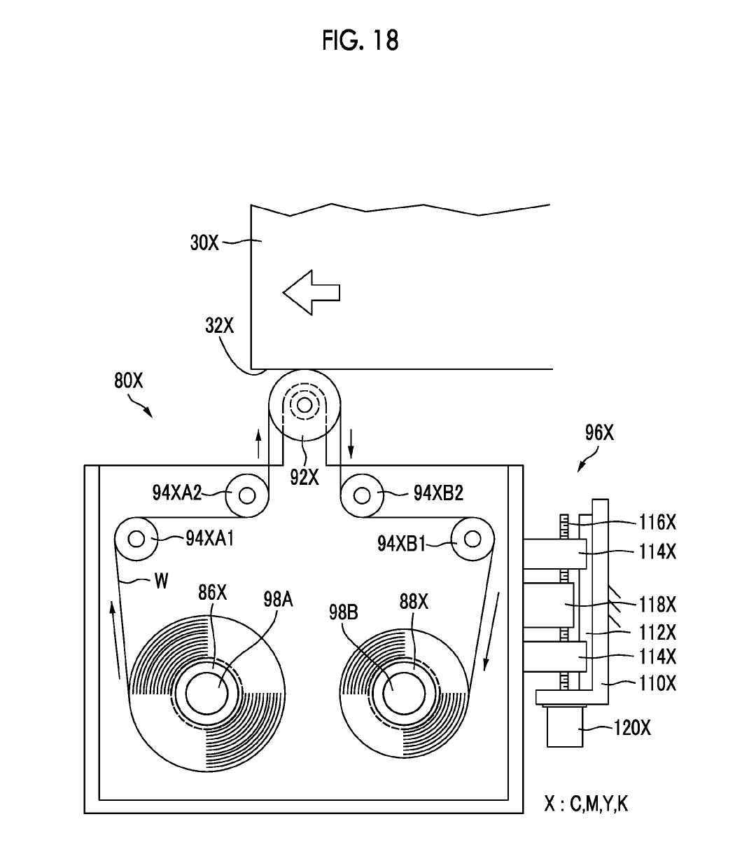

For this, as shown in FIG. 18, it is preferable to enlarge the winding angle of the wiping web W to the pressing roller 92X. In the example shown in this drawing, the traveling of the wiping web W is guided at a right angle by the second feeding-out-side guide roller 94XA2 arranged immediately before the pressing roller 92X, and the traveling of the wiping web W is guided at a right angle by the second winding-up-side guide roller 94XB2 arranged immediately after the pressing roller 92X. Thereby, a traveling path of the wiping web W is formed so that the wiping web W is wound around at a winding angle of 180° to the pressing roller 92X. The nozzle face 32X can be wiped in a state where the raised portion is raised by enlarging the winding angle of the wiping web W to the pressing roller 92X in this way. Accordingly, the nozzle face 32X can be efficiently wiped. The wiping web W is preferably wound around the pressing roller 92X at a winding angle of 180° or more.

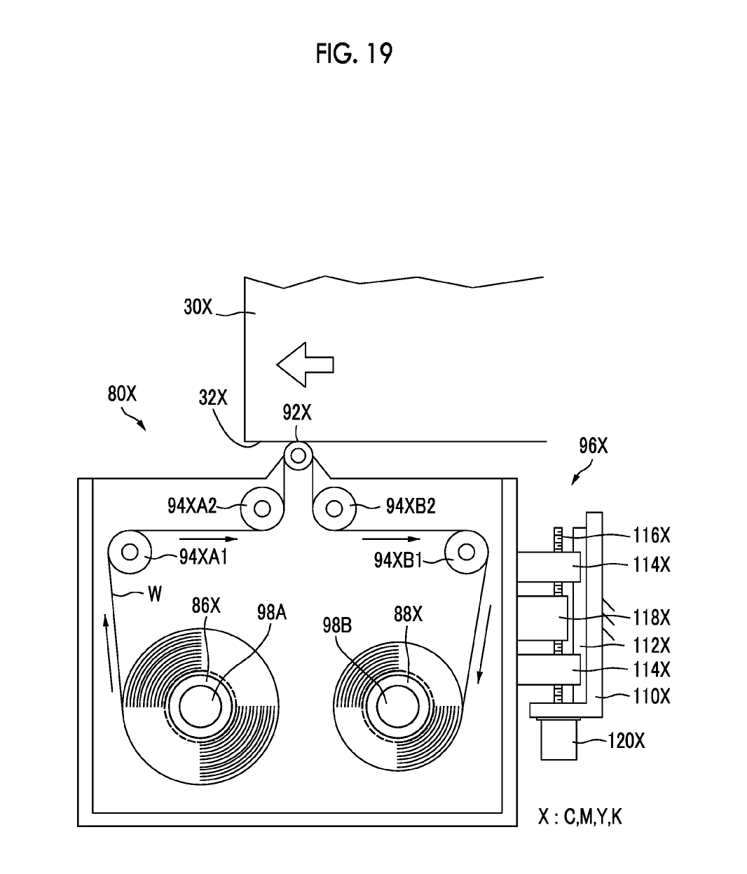

Additionally, as shown in FIG. 19, also by using a smaller-diameter pressing roller 92X, the raised portion can be raised and the nozzle face 32X can be efficiently wiped.

Additionally, the effect of raising the raised portion can be obtained also by forming irregularities (projections and recesses) on the surface of the pressing roller 92X. In this case, if the adhesion between the nozzle face 32X and the wiping web W is lost due to the irregularities (projections and recesses), wiping performance degrades. Thus, it is preferable to form the irregularities so as to have deformable flexibility due to the pressing force of the wiping web W. For example, the effect of forming the irregularities (embossed portions or the like) on the surface of the pressing roller 92X made of rubber to raise the raised portion can be given.

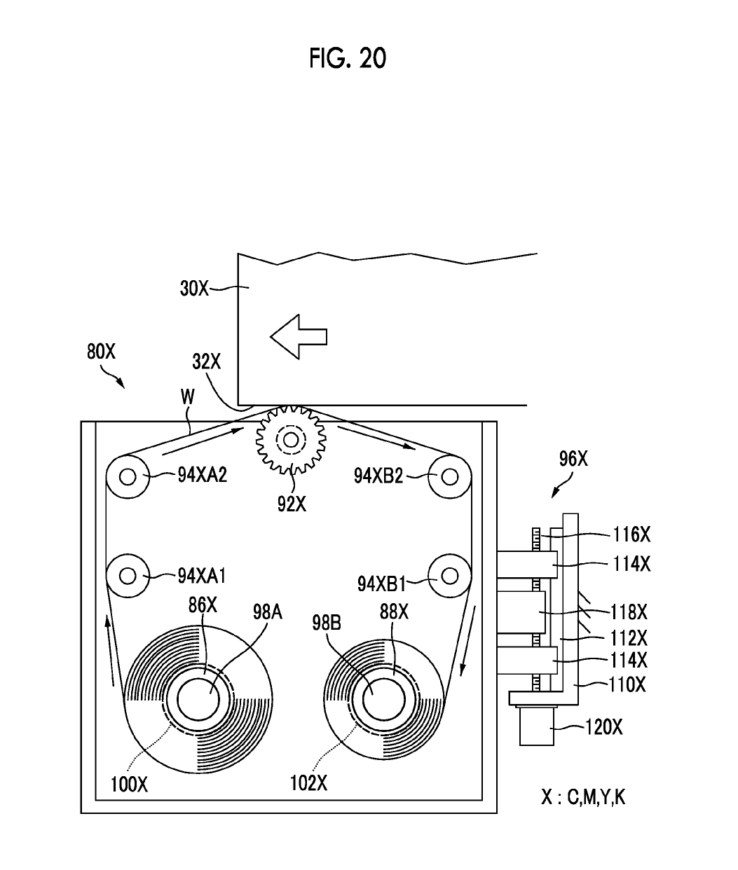

Additionally, as shown in FIG. 20, the effect of raising the raised portion stand can be obtained also by using a pressing roller 92X (a pressing roller in the shape in which a number of grooves parallel to an axis are formed at constant pitches on a peripheral face) with a gear-like cross-section.

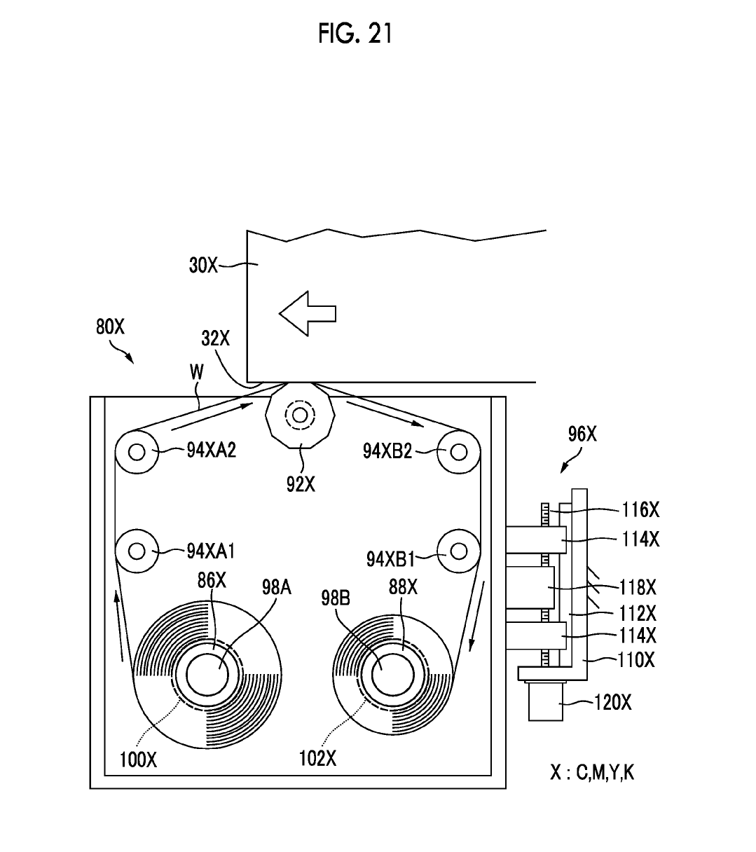

Similarly, as shown in FIG. 21, the effect of raising the raised portion can be obtained also by using a pressing roller 92X with a polygonal cross-section.

Modification 2

Although a configuration in which a cleaning liquid is directly imparted to the nozzle face 32X by the cleaning liquid imparting device 60X to wipe the nozzle face 32X is adopted in the above embodiment, a cleaning liquid may be imparted to the wiping web W, and the nozzle face 32X may be wiped using the wiping web W in which the cleaning liquid has been imparted (so-called wet wiping).

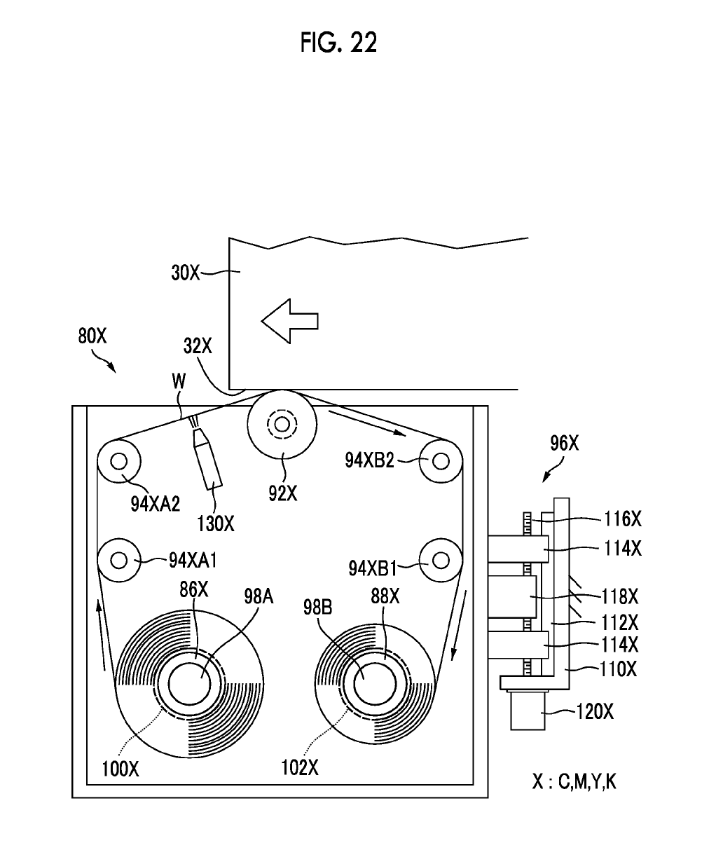

In this case, as shown in FIG. 22, it is preferable to supply a cleaning liquid from the rear face (a face opposite to the wiping surface subjected to raising treatment) of the wiping web W. The example shown in this drawing adopts a configuration in which a cleaning liquid is imparted to the wiping web W by jetting the cleaning liquid toward the rear face of the wiping web W from a cleaning liquid imparting nozzle 130X (cleaning liquid supply unit) at a position immediately before the wiping web W is wound around the pressing roller 92X. By supplying a cleaning liquid from the rear face of the wiping web W in this way, the raised portion can be prevented from getting wet and collapsing due to the liquid, and the nozzle face can be effectively wiped.

In addition, the pressing roller 92X may be constituted with a porous body, and a cleaning liquid may be made to ooze out from the inside of the pressing roller 92X so as to be supplied the wiping web W. That is, the specific supply aspect of the cleaning liquid is not particularly limited as long as the cleaning liquid can be made to ooze out from the rear face side of the wiping web W.

Modification 3

As described above, the wiping web W of which the surface has been subjected to raising treatment can also clean the insides of the nozzles as the raised portion enters the nozzles during wiping. However, if the pressing force to the nozzle face 32X is too strong, the raised portion may collapse and the cleaning effect within the nozzles may decrease. On the other hand, if the wiping web W is strongly pressed, the nozzle face 32X can be thoroughly cleaned by the action of the base texture portion. Accordingly, it is preferable to enable the pressing force of the wiping web W to be adjusted according to the degree of stains or the purpose of cleaning. This adjustment can be performed, for example, by adjusting the position (the position of the wiping device 80X during wiping) of the pressing roller 92X. The control device changes the position (the position of the wiping device 80X during wiping) of the pressing roller 92X according to the mode of cleaning. In the present configuration, the control device is equivalent to a pressing force adjusting unit. The mode of cleaning may include, for example, a mode in which the insides of the nozzles are cleaned, and a mode in which the nozzle face 32X is thoroughly cleaned. In a case where the mode in which the insides of the nozzles are cleaned is selected, the position of the pressing roller 92X is set by moving the wiping device 80X to the first wiping position so that only the raised portion abuts against the nozzle face 32X. On the other hand, in a case where the mode in which the nozzle face 32X is powerfully cleaned is selected, the position of the pressing roller 92X is set by moving the wiping device 80X to the first wiping position so that the base texture portion also abuts against the nozzle face 32X. This makes it possible to more appropriately clean he nozzle face 32X. In addition, the selection of the modes may be performed by a user or may be automatically performed according to a predetermined cleaning program. In a case where the selection of the modes is automatically performed, for example, the modes may be automatically switched according to the number of printed copies, operating time, or the like so as to perform cleaning.

Modification 4

In the above embodiment, the nozzle face 32X is wiped by the wiping web W that is formed in the shape of a band. However, the form of the wiping member that wipes the nozzle face 32X is not limited to the band shape.

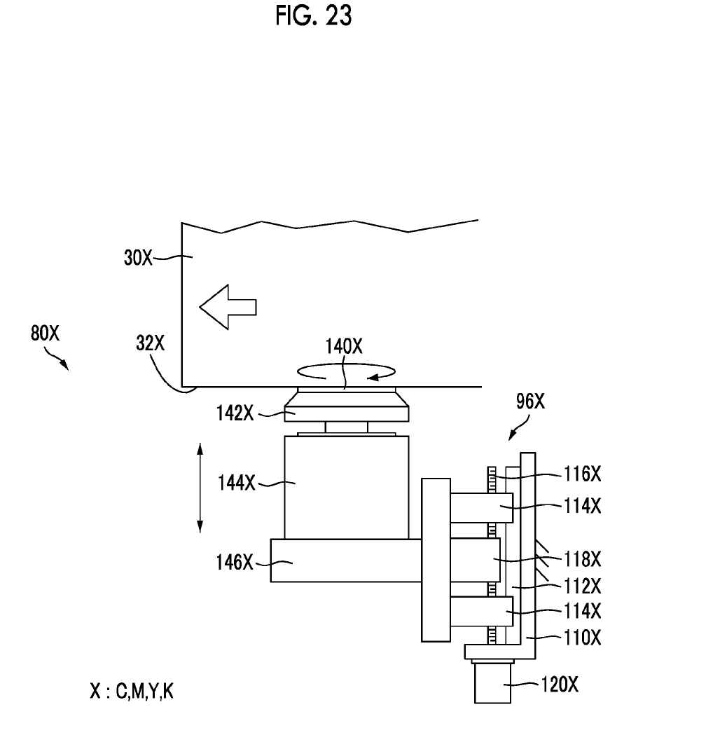

For example, as shown in FIG. 23, the nozzle face 32X may be wiped by making a pad 142X of which the surface is coated with wiping cloth 140X abut against the nozzle face 32X. In this case, similarly to the above-described the wiping web W, raised fabric of which the surface has been subjected to raising treatment (including those having irregularities like a nap or like a brush on the surface thereof) may be used as the wiping cloth 140X.

In addition, the wiping device shown in this drawing is configured so that the pad 142X can be rotated by a pad drive motor 144X (pad drive unit). This makes it possible to make the wiping cloth 140X abut against the nozzle face 32X while rotating the wiping cloth. By making the wiping cloth 140X abut against the nozzle face 32X while rotating the wiping cloth in this way, the portions of the raised yarns can be made to randomly enter the nozzles, and the insides of the nozzles can be more effectively cleaned. Additionally, the nozzle face can also be more effectively cleaned.

Additionally, the pad drive motor 144X is provided on a stage 146X that can be lifted and lowered by the lifting device 96X, and is provided so that the abutment position can be adjusted. This makes it possible to adjust the pressing force according to the degree of stain or the purpose of cleaning and makes it possible to more appropriately clean the nozzle face 32X.

### Other Examples

In order to further enhance the cleaning effect within the nozzles by the raised portion (projection), it is preferable to perform wiping while minutely vibrating the wiping web. Such a configuration can be realized, for example, by imparting minute vibration to the pressing roller. Such a configuration can also be realized, for example, by attaching an ultrasonic vibrator to the pressing roller. That is, supersonic oscillation is imparted to the pressing roller through the ultrasonic vibrator, and minute vibration is imparted to the wiping web wound around the pressing roller. This makes it possible to further improve the cleaning performance within the nozzles.

In addition, although a configuration in which the head side is moved to wipe the nozzle face is adopted in the above embodiment, the wiping device side may be moved to wipe the nozzle face.

Additionally, although a case in which the nozzle face of the line head is cleaned has been described as an example in the above embodiment, the present invention can also be applied to a case where the nozzle face of a shuttle head is cleaned.

Additionally, although a case where the present invention is applied to the ink jet recording apparatus has been described as an example in the above embodiment, application of the invention is not limited to this. The present invention can be used for cleaning of heads for arbitrary applications as long as a head configured to eject droplets an ink jet method is provided.

What is claimed is:

1. A droplet ejection apparatus comprising:
a droplet ejection configured to eject droplets from nozzles formed in a nozzle face; and
a wiping unit configured to move relative to the droplet ejection head to thereby wipe the nozzle face of the droplet ejection head with a wiping member,
wherein the wiping member comprises nap-like or brush-like projections and recesses on a wiping surface, and
wherein the projections of the wiping surface enter the nozzles during wiping of the nozzle face by the wiping member.

2. The droplet ejection apparatus according to claim 1,
wherein the wiping member is constituted by a sheet having a nap on the wiping surface, and
wherein the nap enter the nozzles during the wiping of the nozzle face by the wiping member.

3. The droplet ejection apparatus according to claim 1,
wherein the wiping member is constituted by a sheet having brush bristles on the wiping surface, and
wherein the brush bristles enter the nozzles during the wiping of the nozzle face by the wiping member.

4. The droplet ejection apparatus according to claim 2,
wherein a base material of the sheet is constituted by a sheet formed through knitting or weaving using ultrafine fibers.

5. The droplet ejection apparatus according to claim 3,
wherein a base material of the sheet is constituted by a sheet formed through knitting or weaving using ultrafine fibers.

6. The droplet ejection apparatus according to claim 2,
wherein the wiping unit further comprises a cleaning liquid supply unit configured to supply a cleaning liquid to the wiping member from an opposite side of the wiping surface.

7. The droplet ejection apparatus according to claim 3,
wherein the wiping unit further comprises a cleaning liquid supply unit configured to supply a cleaning liquid to the wiping member from an opposite side of the wiping surface.

8. The droplet ejection apparatus according to claim 2,
wherein the wiping member is in a shape of a band,
wherein the wiping unit comprises a wiping member drive unit configured to make the wiping member travel, and a pressing roller around which the wiping member is wound, and
wherein the wiping unit wipes the nozzle face by making the wiping member wound around the pressing roller abut against the nozzle face.

9. The droplet ejection apparatus according to claim 3,
wherein the wiping member is in a shape of a band,
wherein the wiping unit comprises a wiping member drive unit configured to make the wiping member travel, and a pressing roller around which the wiping member is wound, and
wherein the wiping unit wipes the nozzle face by making the wiping member wound around the pressing roller abut against the nozzle face.

10. The droplet ejection apparatus according to claim 8,
wherein a winding angle of the wiping member to the pressing roller is set to 180° or more.

11. The droplet ejection apparatus according to claim 9,
wherein a winding angle of the wiping member to the pressing roller is set to 180° or more.

12. The droplet ejection apparatus according to claim 8,
wherein a peripheral face of the pressing roller has a projection-recess pattern.

13. The droplet ejection apparatus according to claim 9,
wherein a peripheral face of the pressing roller has a projection-recess pattern.

14. The droplet ejection apparatus according to claim 8,
wherein the pressing roller has a polygonal cross-section.

15. The droplet ejection apparatus according to claim 9,
wherein the pressing roller has a polygonal cross-section.

16. The droplet ejection apparatus according to claim 8,
wherein the wiping unit further comprises a pressing force adjusting unit configured to adjust a position of the pressing roller with respect to the nozzle face to thereby adjust pressing force of the pressing roller.

17. The droplet ejection apparatus according to claim 9,
wherein the wiping unit further comprises a pressing force adjusting unit configured to adjust a position of the pressing roller with respect to the nozzle face to thereby adjust pressing force of the pressing roller.

18. The droplet ejection apparatus according to claim 2,
wherein the wiping unit wipes the nozzle face by making a pad, of which surface is covered with the wiping member, abut against the nozzle face to thereby wipe the nozzle face.

19. The droplet ejection apparatus according to claim 3,
wherein the wiping unit wipes the nozzle face by making a pad, of which surface is covered with the wiping member, abut against the nozzle face to thereby wipe the nozzle face.

20. The droplet ejection apparatus according to claim 19,
wherein the wiping unit further comprises a pad drive unit configured to rotate the pad.
